(19) United States
(12) Patent Application Publication
(10) Pub. No.: US 2025/0380629 A1
(43) Pub. Date: Dec. 18, 2025

(54) ATTACHMENT, CONTINUOUS POT SEEDLING TRANSPLANTER, AND METHOD FOR PRODUCING CROP

(71) Applicant: Nippon Beet Sugar Manufacturing Co., Ltd., Tokyo (JP)

(72) Inventors: Hiroyuki WAKAMATSU, Fukuoka (JP); Naoki KIMURA, Miyagi (JP)

(21) Appl. No.: 18/877,529

(22) PCT Filed: Mar. 6, 2023
(86) PCT No.: PCT/JP2023/008406

§ 371 Date: Dec. 20, 2024

(30) Foreign Application Priority Data
Jun. 21, 2022 (JP) 2022-099596

(51) Int. Cl. A01C 11/02; A01C 11/00

(52) U.S. Cl. CPC A01C 11/025; A01C 11/006

(57) ABSTRACT

Attachment including a base plate and three guiding plates disposed on the base plate is attached to a pot seedling guide portion. The guiding plates are arranged alternately on right and left sides along a reference line L, and resistance imparting portions are arranged on the reference line L. This allows a tensile force to be generated between individual pots and linked by a link piece, and a corrective effect on a posture of the individual pots in contact with guiding surfaces of the guiding plates can be enhanced.

### TECHNICAL FIELD

The present invention relates to an attachment used by being attached to a continuous pot seedling transplanter, a continuous pot seedling transplanter to which the attachment is attached, and a method for producing a crop using the continuous pot seedling transplanter.

### BACKGROUND ART

Patent Document 1 discloses a continuous pot seedling transplanter configured to prevent continuous pot seedlings 7, which are in an inverted state due to twisted link pieces, from entering a pot seedling guide portion 5 by causing the continuous pot seedlings 7 pulled out from a pot seedling placing portion 31 to stand upright with a pair of guide plates 71L, 71R (pot seedling standing means). The continuous pot seedling transplanter (hereinafter referred to as “conventional continuous pot seedling transplanter”) disclosed in Patent Document 1 is effective for long-pitch continuous pot seedlings that are likely to have twisted link pieces.

Patent Document 1: Japanese Patent No. 6550113

### DISCLOSURE OF THE INVENTION

### Problems to be Solved by the Invention

Incidentally, each individual pot of the continuous pot seedlings has a substantially square side surface shape according to the projection drawing method. In view of this, in the conventional continuous pot seedling transplanter, when an upper surface (seedling input surface) of the individual pot comes in contact with the guide plates, which are inclined outward, there is a risk that the continuous pot seedlings may pass through the pot seedling guide portion in an inverted or sideways-tilted posture (hereinafter referred to as a “fallen posture”) and be planted in the field in the fallen posture. Such a problem becomes more pronounced as a remaining portion of an assemblage of continuous pot seedlings placed on the pot seedling placing portion is reduced, and a distance from a dissociation point of the assemblage of continuous pot seedlings to the pot seedling guide portion increases.

An object of the present invention is to provide an attachment for a continuous pot seedling transplanter that can further stabilize a posture of continuous pot seedlings pulled out from an assemblage of continuous pot seedlings, a continuous pot seedling transplanter to which the attachment is attached, and a method for producing a crop using the continuous pot seedling transplanter.

### Solutions to the Problems

An attachment of the present invention is an attachment used by being attached to a continuous pot seedling transplanter. The continuous pot seedling transplanter includes a pot seedling placing portion, a pot seedling guide portion, and a pot seedling delivery portion. The pot seedling placing portion is disposed at a front portion of a transplanter body, and an assemblage of continuous pot seedlings is placed thereon. The pot seedling guide portion aligns a row of continuous pot seedlings pulled out from an assemblage of continuous pot seedlings as the transplanter body moves. The pot seedling delivery portion is disposed at a rear portion of the transplanter body and delivers continuous pot seedlings aligned by the pot seedling guide portion to a planting furrow. The attachment includes a bottom plate and two or more guiding plates. The bottom plate is disposed on the pot seedling guide portion. The two or more guiding plates are disposed on the bottom plate and cause continuous pot seedlings pulled out from an assemblage of continuous pot seedlings to stand upright. The guiding plates are arranged alternately on left and right sides along a movement path of continuous pot seedlings.

A continuous pot seedling transplanter of the present invention includes a pot seedling placing portion, a pot seedling guide portion, and a pot seedling delivery portion. The pot seedling placing portion is disposed at a front portion of a transplanter body, and an assemblage of continuous pot seedlings is placed thereon. The pot seedling guide portion aligns a row of continuous pot seedlings pulled out from the assemblage of continuous pot seedlings as the transplanter body moves. The pot seedling delivery portion is disposed at a rear portion of the transplanter body and delivers continuous pot seedlings aligned by the pot seedling guide portion to a planting furrow. The continuous pot seedling transplanter includes two or more guiding plates that are disposed on a bottom plate of the pot seedling guide portion and cause continuous pot seedlings pulled out from an assemblage of continuous pot seedlings to stand upright. The guiding plates are arranged alternately on left and right sides along a movement path of continuous pot seedlings.

A method for producing a crop of the present invention includes transplanting continuous pot seedlings into a field using the continuous pot seedling transplanter to which the attachment is attached.

### Effects of the Invention

According to the present invention, it is possible to further stabilize the posture of the continuous pot seedlings pulled out from the assemblage of continuous pot seedlings.

### BRIEF DESCRIPTION OF THE DRAWINGS

FIG. 1 is a plan view of a continuous pot seedling transplanter according to a first embodiment.

FIG. 2 is a side view of the continuous pot seedling transplanter according to the first embodiment.

FIG. 3 is a plan view of a guiding plate.

FIG. 4 is a side view of the guiding plate.

FIG. 5 is a plan view of a gauge.

FIG. 6 is an explanatory diagram of the first embodiment illustrating an arrangement of three guiding plates.

FIG. 7 is an explanatory diagram of a modification of the first embodiment illustrating an arrangement of three guiding plates and an arrangeable range of resistance imparting portions.

FIG. 8 is an explanatory diagram of a second embodiment illustrating an arrangement of three guiding plates and an arrangeable range of resistance imparting portions.

FIG. 9 is an explanatory diagram of a third embodiment illustrating an arrangement of two guiding plates.

FIG. 10 is an explanatory diagram of a fourth embodiment illustrating an arrangement of two guiding plates. FIG. 11 is an explanatory diagram of a fifth embodiment.

### DESCRIPTION OF PREFERRED EMBODIMENTS

### First Embodiment

The first embodiment of the present invention will be described with reference to the accompanying drawings.

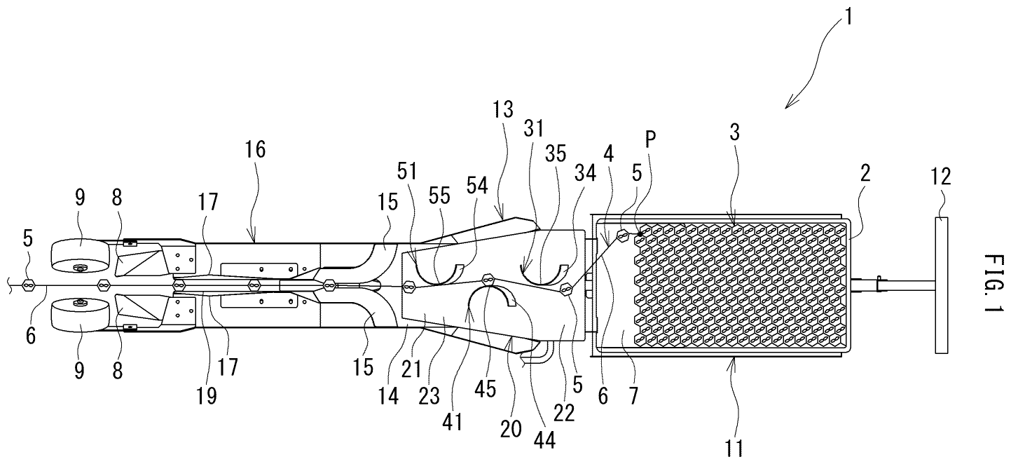

For convenience, the right direction in FIG. 1 is referred to as a front direction, and the left direction in FIG. 1 is referred to as a rear direction. Further, the downward direction in FIG. 1 is referred to as a left direction, and the upward direction in FIG. 1 is referred to as a right direction.

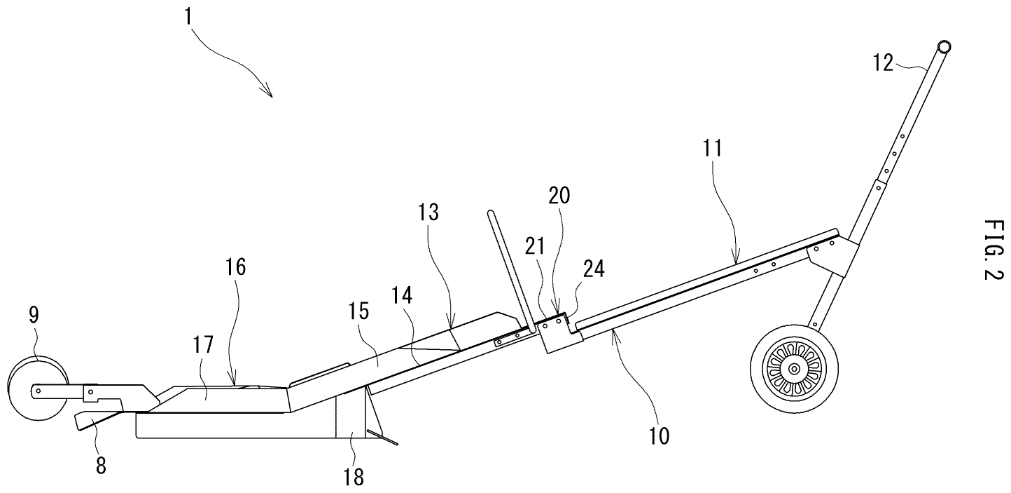

As illustrated in FIG. 1 or FIG. 2, a continuous pot seedling transplanter 1 includes a pot seedling placing portion 11, a pot seedling guide portion 13, and a pot seedling delivery portion 16. The pot seedling placing portion 11 is disposed at a front portion of a transplanter body 10, and an assemblage of continuous pot seedlings 3 is placed thereon. The pot seedling guide portion 13 aligns a row of continuous pot seedlings 4 pulled out from the assemblage of continuous pot seedlings 3 on the pot seedling placing portion 11 as the transplanter body 10 moves. The pot seedling delivery portion 16 is disposed at a rear portion of the transplanter body 10 and delivers the continuous pot seedlings 4 aligned by the pot seedling guide portion 13 to a planting furrow in the field. FIG. 1 shows a state in which a seedling box 2 containing the assemblage of continuous pot seedlings 3 is placed on the pot seedling placing portion 11, and FIG. 2 shows a state in which the seedling box 2 is not placed on the pot seedling placing portion 11.

An attachment 20 is attached to the pot seedling guide portion 13. The attachment 20 functions as pot seedling standing means for causing the continuous pot seedlings 4 pulled out from the assemblage of continuous pot seedlings 3 to stand upright. The attachment 20 is attached to the existing continuous pot seedling transplanter 1. Accordingly, for the purpose of simplifying the description herein, the detailed explanation on the continuous pot seedling transplanter 1 is omitted. For convenience, an upstream side (“right side” in FIG. 1) of a movement path of the continuous pot seedlings 4 in the transplanter body 10 is referred to as the “upstream side,” and a downstream side (“left side” in FIG. 1) of the movement path of the continuous pot seedlings 4 is referred to as the “downstream side.”

The attachment 20 includes a base plate 21 (bottom plate) mounted on a bottom plate 14 of the pot seedling guide portion 13, and three guiding plates 31, 41, 51 arranged on the base plate 21. The base plate 21 is made of a steel plate, and is mounted at an angle so as to have a lowered rear portion. The base plate 21 has a front portion 22 and a rear portion 23. The front portion 22 is formed in a rectangular shape having substantially the same width as a width (length in the left-right direction) of the bottom plate 14. The rear portion 23 is formed in an isosceles trapezoid having a width narrowing in the rear direction. In other words, the base plate 21 has a symmetrical hexagonal shape in a plan view.

The base plate 21 has a perpendicular piece 24 formed by bending a front end portion (front portion 22) at a right angle downward. The base plate 21 is restricted from moving in the rear direction relative to the pot seedling guide portion 13 by causing the perpendicular piece 24 to come in contact with (hook onto) the front end surface (reference numeral omitted) of the pot seedling guide portion 13. For convenience, a straight line extending in the front-rear direction at the center in the width direction (left-right direction) of the bottom plate 14 of the pot seedling guide portion 13 is defined as a reference line L (see FIG. 6). The symmetrical axis of the base plate 21 coincides with the reference line L.

As illustrated in FIG. 6, the guiding plates 31, 41, 51 are arranged alternately on left and right sides along the reference line L (spaced apart from each other in the front-rear direction). The guiding plates 31, 51 are arranged on the right side of the reference line L, and the guiding plate 41 is arranged on the left side of the reference line L. The guiding plate 31 is arranged at the most upstream of the movement path of the continuous pot seedlings 4 (a position closest to the assemblage of continuous pot seedlings 3), and the guiding plate 51 is arranged at the most downstream of the movement path of the continuous pot seedlings 4 (a position farthest from the assemblage of continuous pot seedlings 3). The guiding plate 41 is arranged at an intermediate position between the guiding plate 31 and the guiding plate 51 in the front-rear direction.

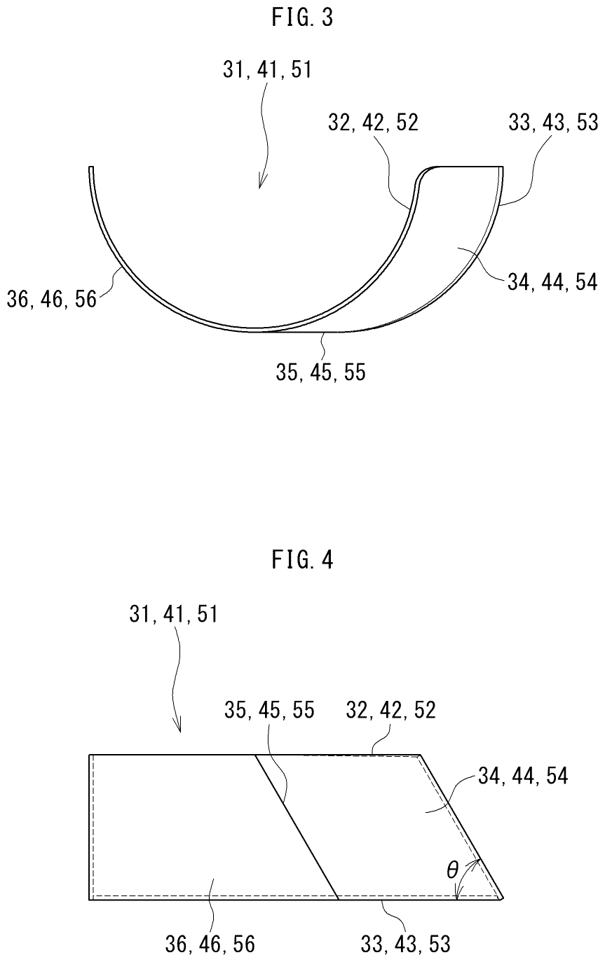

As illustrated in FIG. 3 or FIG. 4, the guiding plate 31 is obtained by curving (R-bending) a steel plate such that the left side (“lower side” in FIG. 3) is convex in a plan view (see FIG. 3). The guiding plate 31 has an upper end edge 32 formed in a semicircular shape and a lower end edge 33 formed in a semi-oval shape having the same radius of curvature as the upper end edge 32. In a plan view, a downstream end position of the upper end edge 32 and a downstream end position of the lower end edge 33 of the guiding plate 31 are the same in the front-rear direction and the left-right direction in design. On the other hand, while an upstream end position of the upper end edge 32 and an upstream end position of the lower end edge 33 of the guiding plate 31 are the same in the left-right direction in design, the upstream end position of the lower end edge 33 is further located in the front direction (upstream) of the upstream end position of the upper end edge 32.

This causes a surface 37 (hereinafter referred to as a “guiding surface 34”) of the guiding plate 31 oriented toward the front direction (upstream) to be inclined so as to fall backward relative to the base plate 21. The guiding surface 34 includes a smooth curved surface that is convex toward the movement path of the continuous pot seedlings 4, and an inclination angle θ (see FIG. 4) relative to the base plate 21 from the upstream end thereof to a resistance imparting portion 35 described later is not particularly limited and can be appropriately set as long as it can act to correct the continuous pot seedlings 4 in the fallen posture to a standing posture. The inclination angle θ can be provided, for example, in a range of 45° (backward inclination) to 110° (forward inclination). As an example of this, the inclination angle θ of the upstream end of the guiding plate 31 relative to the base plate 21 is from 45° (backward inclination) to 90° (perpendicular), and an inclination angle θ of the resistance imparting portion 35 relative to the base plate 21 is from 60° (backward inclination) to 110° (forward inclination). The guiding plate 31 may be reinforced by providing a bottom plate or the like.

The guiding plate 31 has the resistance imparting portion 35 that is brought into contact with the continuous pot seedlings 4. The resistance imparting portion 35 acts to impart a resistance against the moving direction to the continuous pot seedlings 4. The resistance imparting portion 35 is disposed at a position farthest from the upstream end of the guiding plate 31 (“front end of the lower end edge 33” in the first embodiment) in the left-right direction, in other words, at a position closest to the reference line L in the left-right direction. The resistance imparting portion 35 in the first embodiment is a ridge portion between the guiding surface 34 and a non-guiding surface 36 in contact with the guiding surface 34. In the first embodiment, an inclination angle of the non-guiding surface 36 relative to the base plate 21 is 90°.

Here, the guiding plate 51 has the same shape as the guiding plate 31. The guiding plate 41 has a shape symmetrical to the guiding plates 31, 51. Accordingly, for the purpose of simplifying the description herein, the detailed explanation on the guiding plates 41, 51 is omitted.

As illustrated in FIG. 6, positions of the guiding plates 31, 41, 51 in the left-right direction are determined such that resistance imparting portions 35, 45, 55 are located on the reference line L. In other words, the guiding plates 31, 41, 51 are arranged so as to be in contact with the reference line L at the resistance imparting portions 35, 45, 55. Positions of the guiding plates 31, 41, 51 in the front-rear direction are determined such that two individual pots 5 of the continuous pot seedlings 4 pulled out from the assemblage of continuous pot seedlings 3 (see FIG. 1) do not simultaneously come in contact with the resistance imparting portions 35, 45, 55.

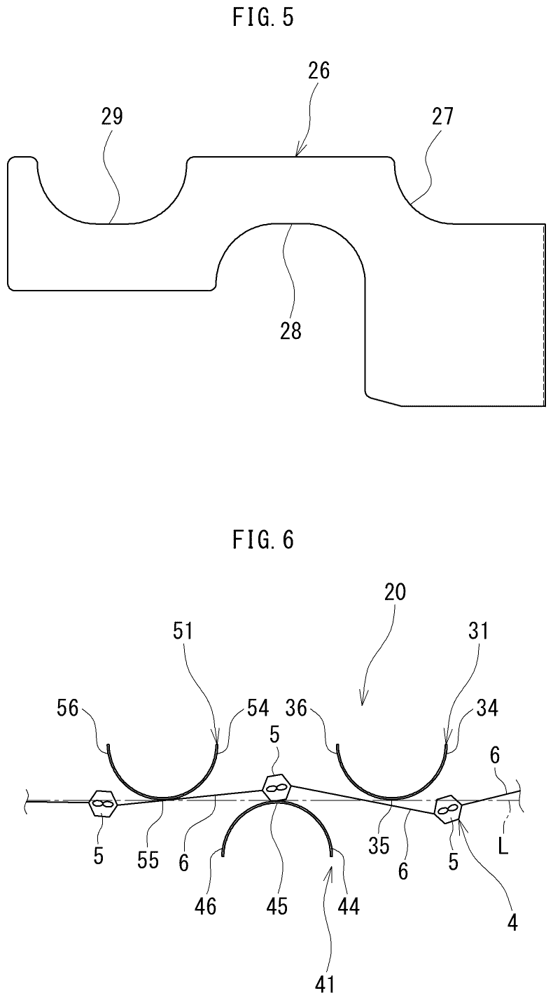

The positions of the guiding plates 31, 41, 51 are adjusted using a gauge 26 illustrated in FIG. 5. The gauge 26 is provided with a first cutout portion 27 that determines the position of the guiding plate 31, a second cutout portion 28 that determines the position of the guiding plate 41, and a third cutout portion 29 that determines the position of the guiding plate 51.

Next, a method for producing a crop using the continuous pot seedling transplanter 1 in which the attachment 20 is attached to the pot seedling guide portion 13 will be described.

First, the seedling box 2 (see FIG. 1) is set on the pot seedling placing portion 11. In the seedling box 2, the assemblage of continuous pot seedlings 3 in which each individual pot 5 contains soil and seedlings is set. A plate-shaped slope 7 is inserted between the seedling box 2 and the assemblage of continuous pot seedlings 3 to eliminate a difference in level between the seedling box 2 and the pot seedling guide portion 13. The assemblage of continuous pot seedlings 3 is moistened to the extent that a water-soluble glue used for adhesion is dissolved.

Next, the continuous pot seedling transplanter 1 is positioned at a planting start position in the field (not illustrated). Then, a row of the continuous pot seedlings 4 pulled out from the assemblage of continuous pot seedlings 3 contained in the seedling box 2 is caused to pass through between the guiding plates 31 and 41 and between the guiding plates 41 and 51 of the attachment 20, between a pair of guide plates 15 and 15 of the pot seedling guide portion 13, and between a pair of leading plates 17 and 17 of the pot seedling delivery portion 16, and a distal end thereof is planted and fixed in the planting furrow (not illustrated) formed in the field.

Next, the operator pulls a handle 12 to move the continuous pot seedling transplanter 1 in the front direction. As the continuous pot seedling transplanter 1 moves, a furrow opener 18 forms the planting furrow in the field. Simultaneously, the continuous pot seedlings 4 are sequentially pulled out from the assemblage of continuous pot seedlings 3 contained in the seedling box 2, caused to pass through the movement path, that is, between the guiding plates 31 and 41 and between the guiding plates 41 and 51 of the attachment 20, between the pair of guide plates 15 and 15 of the pot seedling guide portion 13, and between the pair of leading plates 17 and 17 of the pot seedling delivery portion 16 to be aligned, and delivered from a cutout portion 19 to the planting furrow. The continuous pot seedlings 4 delivered from the cutout portion 19 are fixed in the field as the surrounding soil, raked up by a pair of furrowers 8, 8, is compacted by a pair of land rollers 9, 9.

Here, since each individual pot of the continuous pot seedlings has a substantially square side surface shape according to the projection drawing method, in the conventional continuous pot seedling transplanter, when the upper surface (seedling input surface) of the individual pot comes in contact with the guide plates, which are inclined outward, there is a risk that the continuous pot seedlings may pass through the pot seedling guide portion in the fallen posture (inverted or sideways-tilted posture) and be planted in the field in the fallen posture.

Such a problem becomes more pronounced as a remaining portion of the assemblage of continuous pot seedlings placed on the pot seedling placing portion is reduced, and a distance from a dissociation point P (see FIG. 1) of the assemblage of continuous pot seedlings to the pot seedling guide portion increases. The individual pot in the sideways-tilted posture is inverted in a process of passing through the pot seedling guide portion, and this is triggered by a phenomenon in which dissociation of the continuous pot seedlings in the assemblage of continuous pot seedlings is not smoothly performed and a tensile force acts irregularly on the moving continuous pot seedlings, a phenomenon in which the continuous pot seedlings collide with an obstacle such as soil or seedlings present on the movement path of the continuous pot seedlings, or the like.

As a countermeasure against this, in the first embodiment, the attachment 20 including the base plate 21 (bottom plate) and the three guiding plates 31, 41, 51 arranged on the base plate 21 is attached to the pot seedling guide portion 13. The guiding plates 31, 41, 51 are arranged alternately on the left and right sides along the reference line L (spaced apart from each other in the front-rear direction), and the resistance imparting portions 35, 45, 55 are disposed at positions farthest from the upstream ends of the guiding plates 31, 41, 51 in the left-right direction (on the reference line L in the first embodiment).

Thus, in the first embodiment, the continuous pot seedlings 4 pulled out from the assemblage of continuous pot seedlings 3 come in contact with at least two of the resistance imparting portions among the resistance imparting portions 35, 45, 55 of the three guiding plates 31, 41, 51, and a tensile force acts between the individual pots 5, 5 linked by the link piece 6. The tensile force generated between this preceding individual pot 5 and the subsequent individual pot 5 on the upstream side increases particularly while the individual pot 5 on the upstream side comes in contact with the guiding surface 34 (or 44) of the guiding plate 31 (or 41) and reaches the resistance imparting portion 35 (or 45). At this time, since the resistance received by the subsequent individual pot 5 on the upstream side increases by coming in contact with the guiding surface 34 (or 44) or the resistance imparting portion 35 (or 45) of the guiding plate 31 (or 41), an effect of correcting the posture of the individual pot 5 to the angle of the contacting surface relative to the base plate 21 can be enhanced. Further, at this time, the continuous pot seedlings 4 are in contact with the resistance imparting portion 45 (or 55) of the guiding plate 41 (or 51) on the downstream side, thereby allowing the posture of the continuous pot seedlings 4 between the guiding plate 31 (or 41) on the upstream side and the guiding plate 41 (or 51) on the downstream side to be maintained in the standing posture. This also can act to maintain the posture of the continuous pot seedlings 4 moving downstream of the guiding plate 41 (or 51) on the downstream side in the standing posture.

Since the tensile force acting between the individual pots 5, 5 can also be transmitted to the continuous pot seedlings 4 dissociated from the assemblage of continuous pot seedlings 3 before reaching the guiding plate 31, twisting that occurs in the link piece 6 between the individual pots 5 on the further upstream side can be suppressed, and the correction of the posture of the continuous pot seedlings 4 by the guiding surface 34 of the guiding plate 31 can be assisted.

In the first embodiment, the positions of the guiding plates 31, 41, 51 in the front-rear direction are determined such that two individual pots 5 of the continuous pot seedlings 4 pulled out from the assemblage of continuous pot seedlings 3 do not simultaneously come in contact with the resistance imparting portions 35, 45, 55. Therefore, it is possible to suppress an excessive tensile force acting on the continuous pot seedlings 4, and thus avoiding a hindrance to a smooth movement of the continuous pot seedlings 4 or a situation where the link piece 6 is damaged.

Thus, in the first embodiment, the posture of the continuous pot seedlings 4 pulled out from the assemblage of continuous pot seedlings 3 can be further stabilized, and a planting accuracy of the continuous pot seedling transplanter 1 can be improved.

The embodiment is not limited to the above-described embodiment, and for example, the embodiment can be configured as follows.

In the first embodiment, as the moving speed of the continuous pot seedling transplanter 1 increases, such as when the continuous pot seedling transplanter 1 is coupled to a traveling machine body like a tractor to increase the traveling speed to perform planting, the speed of pulling out the continuous pot seedlings 4 from the assemblage of continuous pot seedlings 3, and thus the moving speed of the continuous pot seedlings 4 moving on the base plate 21 of the attachment 20 (hereinafter referred to as the “moving speed of the continuous pot seedlings 4”), also increases. As the moving speed of the continuous pot seedlings 4 increases, the resistance between the continuous pot seedlings 4 and the resistance imparting portions 35, 45, 55 of the guiding plates 31, 41, 51 arranged on the base plate 21 (hereinafter referred to as the “resistance acting on the continuous pot seedlings 4”) increases.

At this time, when an excessive resistance acts on the continuous pot seedlings 4, the link piece 6 of the continuous pot seedlings 4 may be cut, or a large tensile force may act on the continuous pot seedlings 4 delivered to the planting furrow in the field, causing a planting depth of the individual pot 5 to be shallow. Accordingly, when the moving speed of the continuous pot seedling transplanter 1 is high, it is necessary to suppress an increase in the resistance acting on the continuous pot seedlings 4.

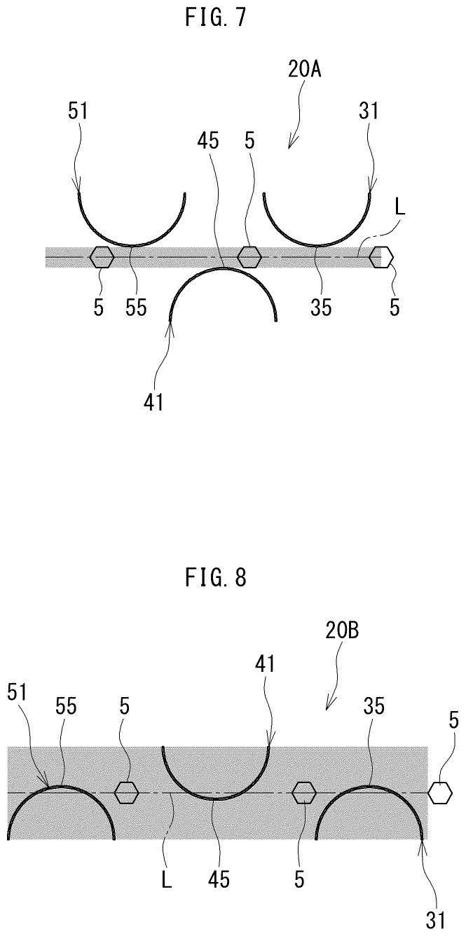

Therefore, in the aspect illustrated in FIG. 7, the attachment 20A is configured such that the resistance imparting portions 35, 45, 55 are arranged at a distance of less than ½ times the diameter of the individual pot 5 from the reference line L, and the guiding plates 31, 41, 51 do not overlap (do not intersect at two points) with the reference line L. In other words, the guiding plates 31, 41, 51 are arranged such that the resistance imparting portions 35, 45, 55 are located within a range of less than ½ times the diameter of the individual pot 5 in the left-right direction relative to the reference line L (within a range indicated by a gray scale in FIG. 7) to configure the attachment 20A.

Here, when compared with the aspect illustrated in FIG. 6, the aspect illustrated in FIG. 7 can effectively suppress an increase in the resistance acting on the continuous pot seedlings 4 in a region where the moving speed of the continuous pot seedling transplanter 1 is high, thereby eliminating problems such as the cutting of the link piece 6 or the unstable planting depth of the individual pot 5 due to an excessive resistance acting on the continuous pot seedlings 4. In the aspect illustrated in FIG. 7, this can increase the moving speed of the continuous pot seedling transplanter 1 to improve a production efficiency.

In the first embodiment, the guiding plates 31, 41, 51 are fixed to the base plate 21 by welding. Further, while the guiding plates 31, 41, 51 are attached to the base plate 21 in the first embodiment, the guiding plates 31, 41, 51 may be directly attached to the bottom plate 14 of the pot seedling guide portion 13 to configure the attachment 20. In this case, the base plate 21 (bottom plate) and the bottom plate 14 of the pot seedling guide portion 13 are equivalent in concept.

While the base plate 21 is provided so as to overlap with the bottom plate 14 (parallel to the bottom plate 14) of the pot seedling guide portion 13 in the first embodiment, the base plate 21 may be provided so as to be inclined in the front-rear direction relative to the bottom plate 14 of the pot seedling guide portion 13.

While the reference line Lis set at a position extending in the front-rear direction at the center of the width direction (left-right direction) of the bottom plate 14 of the pot seedling guide portion 13 in the first embodiment, the reference line L may be set on either left or right side of the center in the left-right direction as long as it is on a straight line extending parallel to the same direction as the traveling direction of the transplanter.

In addition, the reference line L may be set at a position extending forward from between the pair of guide plates 15, 15. That is, even when the reference line Lis provided on a line extending at an angle not parallel to the traveling direction of the transplanter, by setting the continuous pot seedlings 4 to be guided between the pair of guide plates 15, 15, the smooth planting of the continuous pot seedlings 4 is not hindered, and the posture of continuous pot seedlings 4 pulled out from the assemblage of continuous pot seedlings 3 can be further stabilized.

Further, while the guiding plate 31 is provided such that the upper end edge 32 is formed in a semicircular shape and the lower end edge 33 is formed in a semi-oval shape having the same radius of curvature as the upper end edge 32 in the first embodiment, the guiding plate 31 may be provided such that the lower end edge 33 is formed in a semicircular shape having the same radius of curvature as the upper end edge 32. This causes the guiding surface 34 of the guiding plate 31 oriented toward the front direction (upstream) to have an inclination angle θ relative to the base plate 21 of 90° (perpendicular) relative to the base plate 21.

In addition, while non-guiding surfaces 36, 46, 56 are provided on the downstream side of the resistance imparting portions 35, 45, 55 of the guiding plates 31, 41, 51 in the first embodiment, the non-guiding surfaces 36, 46, 56 are not essential. That is, the guiding plates 31, 41, 51 may have upper end edges 32, 42, 52 formed in a minor arc shape. In addition to this, the guiding plates 31, 41, 51 may also be formed in a cylindrical shape, an oval cylindrical shape, an elliptical cylindrical shape, a polygonal column shape, a circular cone shape, an elliptical cone shape, an inverted elliptical cone shape, or a polygonal pyramid shape.

### Second Embodiment

Next, the second embodiment will be described with reference to FIG. 8.

For the configurations in common with the first embodiment, the same appellations and the same reference numerals are used, and redundant descriptions will be omitted.

In the first embodiment, the guiding plates 31, 41, 51 are arranged alternately on the left and right sides relative to the reference line L on the base plate 21 (see FIG. 1) to configure the attachment 20. In contrast, in the second embodiment, the guiding plates 31, 41, 51 are arranged on the reference line L to configure an attachment 20B. That is, the guiding plates 31, 41, 51 are arranged so as to intersect with the reference line L at two points.

In the second embodiment, the guiding plates 31, 41, 51 are arranged on the reference line L such that the resistance imparting portions 35, 45, 55 are arranged at a distance within twice the diameter of the individual pot 5 from the reference line L. In other words, the guiding plates 31, 41, 51 are arranged such that the resistance imparting portions 35, 45, 55 are located within a range of twice the diameter of the individual pot 5 in the left-right direction relative to the reference line L (within a range indicated by a gray scale in FIG. 8). Also in this case, the guiding plates 31, 41, 51 are arranged so as to intersect with the reference line L at two points.

In addition, the attachment 20B may be configured by combining the following aspects: the aspect in which the resistance imparting portions 35, 45, 55 are arranged at a distance of less than ½ times the diameter of the individual pot 5 from the reference line L, and the guiding plates 31, 41, 51 are arranged at positions spaced from the reference line L (see FIG. 7); and the aspect in which the resistance imparting portions 35, 45, 55 are arranged at a distance within twice the diameter of the individual pot 5 from the reference line L, and the guiding plates 31, 41, 51 are arranged on the reference line (see FIG. 8).

The second embodiment can provide operational advantages similar to those of the first embodiment described above.

In the second embodiment, the continuous pot seedlings 4 pulled out from the assemblage of continuous pot seedlings 3 move in a meandering manner in the left-right direction on the base plate 21 of the attachment 20B. In order to avoid an excessive resistance (frictional force) generated between the continuous pot seedlings 4 and the resistance imparting portions 35, 45, 55, it is necessary to adjust the spacing between the guiding plates 31, 41, 51 (resistance imparting portions 35, 45, 55) in the front-rear direction and to reduce the moving speed of the continuous pot seedlings 4.

### Third Embodiment

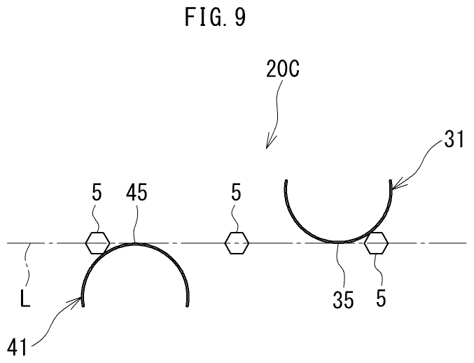

Next, the third embodiment will be described with reference to FIG. 9.

For the configurations in common with the first or the second embodiment, the same appellations and the same reference numerals are used, and redundant descriptions will be omitted.

In the first and second embodiments, the three guiding plates 31, 41, 51 are arranged on the base plate 21 (see FIG. 1) to configure the attachments 20, 20A, 20B. In contrast, in the third embodiment, only two guiding plates 31, 41 are arranged on the base plate 21 to configure an attachment 20C. In the third embodiment, the guiding plates 31, 41 are arranged alternately on the left and right sides along the reference line L (spaced apart from each other in the front-rear direction), and the resistance imparting portions 35, 45 are arranged on the reference line L. Especially when the moving speed of the continuous pot seedlings 4 increases, such as when the continuous pot seedling transplanter 1 is coupled to a traveling machine body like a tractor to increase the traveling speed to perform planting, in order to avoid an excessive resistance (frictional force) generated between the continuous pot seedlings 4 and the resistance imparting portions 35, 45, the distance between the guiding plates 31 and 41 in the front-rear direction (distance between the resistance imparting portions 35 and 45) is adjusted as appropriate. In addition, the attachment 20C may be configured such that the resistance imparting portions 35, 45 are arranged at a distance of less than ½ times the diameter of the individual pot 5 (within the range indicated by the gray scale in FIG. 7) from the reference line L, and the guiding plates 31, 41 do not overlap (do not intersect at two points) with the reference line L.

As described above, as the moving speed of the continuous pot seedlings 4 increases, the resistance acting on the continuous pot seedlings 4 also increases. When an excessive resistance acts on the continuous pot seedlings 4, the link piece 6 of the continuous pot seedlings 4 may be cut, or a large tensile force may act on the continuous pot seedlings 4 delivered to the planting furrow in the field, causing the planting depth of the individual pot 5 to be shallow. Accordingly, in a region where the moving speed of the continuous pot seedling transplanter 1 is high, it is necessary to suppress an increase in the resistance acting on the continuous pot seedlings 4.

Further, when the individual pot 5 has a high center of gravity, such as when a leaf length of the seedlings planted in the individual pot 5 is long, it is necessary to further enhance the corrective effect to correct the fallen posture to the standing posture. Therefore, it is preferable to use the attachments 20, 20B configured by arranging the three guiding plates 31, 41, 51. On the other hand, in the planting of the individual pot 5 in which a leaf length of the planting seedlings is short and the center of gravity is low compared with the above-described individual pot 5, it is not necessary to excessively exert the corrective effect to the standing posture on the continuous pot seedlings 4. Therefore, the present configuration that suppresses an increase in the resistance acting on the continuous pot seedlings 4 is more effective.

Therefore, in the third embodiment, since only two guiding plates 31, 41 are arranged to configure the attachment 20C, it is possible to suppress an increase in the resistance acting on the continuous pot seedlings 4 in the region where the moving speed of the continuous pot seedling transplanter 1 is high as compared with the attachment 20 (see FIG. 6) configured by arranging the three guiding plates 31, 41, 51.

Meanwhile, when only two guiding plates 31, 41 are arranged to configure the attachment 20C (see FIG. 9), there is more chance for the continuous pot seedlings 4 pulled out in a zigzag pattern in the left-right direction from the assemblage of continuous pot seedlings 3 to be in contact with only the guiding plate 41 on the downstream side, as compared with the attachment 20 (see FIG. 6) configured by arranging the three guiding plates 31, 41, 51. In other words, the time during which the continuous pot seedlings 4 are simultaneously in contact with the two guiding plates 31, 41 to receive the corrective effect on the posture is reduced.

On the other hand, as the moving speed of the continuous pot seedling transplanter 1, and thus the moving speed of the continuous pot seedlings 4 increases, the individual pot 5 in contact with the guiding plate 41 in the downstream side (hereinafter referred to as the “preceding individual pot 5”) increases the force of pulling the subsequent individual pot 5 via the link piece 6, that is, the tensile force acting between the individual pots 5, 5 linked by the link piece 6. The tensile force allows the posture of the subsequent individual pot 5 to be aligned with the standing posture of the preceding individual pot 5, thus enhancing the corrective effect on the posture of the individual pot 5. That is, even when the continuous pot seedlings 4 are switched from a state in which they are simultaneously in contact with the two guiding plates 31, 41 to a state in which they are in contact with only the guiding plate 41 on the downstream side, the posture of the subsequent continuous pot seedlings 4 on the upstream side of the guiding plate 41 on the downstream side can be corrected and maintained in the standing posture, and the occurrence of the twisted link piece 6 can be suppressed. Thus, in the third embodiment, it is possible to suppress an increase in the resistance acting on the continuous pot seedlings 4 in the region where the moving speed of the continuous pot seedling transplanter 1 is high, and to enhance the corrective effect on the posture of the individual pot 5.

### Fourth Embodiment

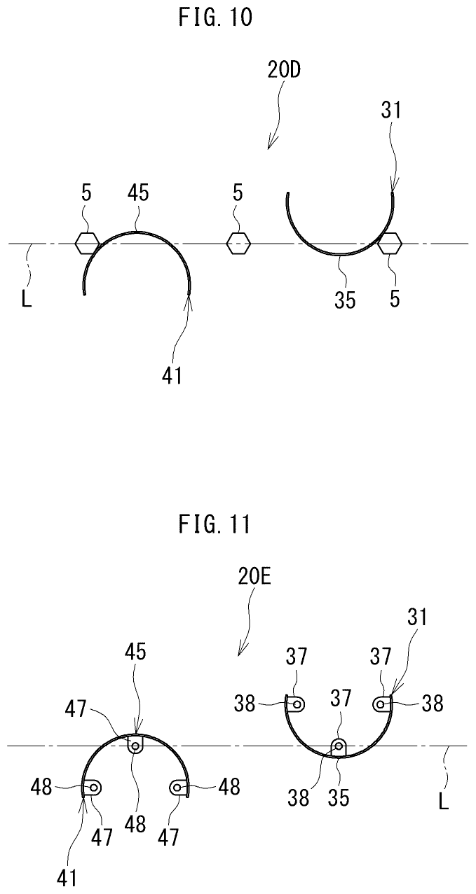

Next, the fourth embodiment will be described with reference to FIG. 10.

For the configurations in common with the first to third embodiments, the same appellations and the same reference numerals are used, and redundant descriptions will be omitted.

In the third embodiment, the two guiding plates 31, 41 are arranged alternately on the left and right sides along the reference line L (spaced apart from each other in the front-rear direction) on the base plate 21 (see FIG. 1), and the resistance imparting portions 35, 45 are arranged on the reference line L to configure the attachment 20C. In contrast, in the fourth embodiment, the guiding plates 31, 41 are arranged so as to overlap with the reference line L, that is, to intersect with the reference line L at two points, to configure an attachment 20D. In order to avoid an excessive resistance (frictional force) generated between the continuous pot seedlings 4 and the resistance imparting portions 35, 45, the distance between the guiding plates 31 and 41 in the front-rear direction (distance between the resistance imparting portions 35 and 45) is adjusted as appropriate.

According to the fourth embodiment, the guiding plate 31 on the upstream side is arranged so as to enter inside the reference line L, and this can reduce the chance for the continuous pot seedlings 4 pulled out in a zigzag pattern in the left-right direction from the assemblage of continuous pot seedlings 3 to be away from the guiding plate 31 on the upstream side, in other words, it becomes possible to increase the time during which the continuous pot seedlings 4 are simultaneously in contact with the two guiding plates 31, 41. Thus, even the two guiding plates 31, 41 can stabilize the tensile force generated between the individual pots 5 and 5 linked by the link piece 6, improving the corrective effect on the posture of the individual pots 5 in contact with the guiding plates 31, 41.

### Fifth Embodiment

Next, the fifth embodiment will be described with reference to FIG. 11.

For the configurations in common with the first to fourth embodiments, the same appellations and the same reference numerals are used, and redundant descriptions will be omitted.

In the first embodiment, the guiding plates 31, 41, 51 are fixed (joined) to the base plate 21 by welding. In contrast, in the fifth embodiment, the guiding plates 31, 41 are attached to the base plate 21 (see FIG. 1) by a magnetic force to configure an attachment 20E. As illustrated in FIG. 11, a plurality of (“three” in the fifth embodiment) flange portions 37, 47 protruding inward are disposed on the lower end edge of the guiding plates 31, 41. Magnets 38, 48 are disposed on the flange portions 37, 47 of the guiding plates 31, 41, respectively. A ferromagnetic material such as a steel plate is used for the base plate 21.

With the fifth embodiment, depending on a length of the link piece 6 of the continuous pot seedlings 4, the moving speed of the continuous pot seedling transplanter 1 (moving speed of the continuous pot seedlings 4), or the like, the arrangement of the guiding plates 31, 41 can be changed as appropriate, and the degree of posture correction of the individual pot 5 can be adjusted as necessary.

The fourth embodiment may be configured such that the guiding plates 31, 41 are attached to the base plate 21 so as to be rearrangeable by adhesion means such as an adhesive tape. The guiding plates 31, 41 may also be directly attached to the bottom plate 14 of the pot seedling guide portion 13 by these attachment methods.

### DESCRIPTION OF REFERENCE SIGNS

1 Continuous pot seedling transplanter
3 Assemblage of continuous pot seedlings
4 Continuous pot seedlings
10 Transplanter body
11 Pot seedling placing portion
13 Pot seedling guide portion
16 Pot seedling delivery portion
20 Attachment
21 Base plate (bottom plate)
31, 41, 51 Guiding plate

1-18. (canceled)

19. An attachment used by being attached to a continuous pot seedling transplanter, wherein
the continuous pot seedling transplanter includes:
a pot seedling placing portion disposed at a front portion of a transplanter body on which an assemblage of continuous pot seedlings is placed;
a pot seedling guide portion that aligns a row of continuous pot seedlings pulled out from an assemblage of continuous pot seedlings as the transplanter body moves; and
a pot seedling delivery portion that is disposed at a rear portion of the transplanter body and delivers continuous pot seedlings aligned by the pot seedling guide portion to a planting furrow, wherein
the attachment comprises:
a bottom plate disposed on the pot seedling guide portion; and
two or more guiding plates that are disposed on the bottom plate and cause continuous pot seedlings pulled out from an assemblage of continuous pot seedlings to stand upright, wherein
the guiding plates are arranged alternately on left and right sides along a movement path of continuous pot seedlings.

20. The attachment according to claim 19, wherein
the guiding plate includes a resistance imparting portion that comes in contact with continuous pot seedlings to impart a resistance against a moving direction, and
the resistance imparting portion is disposed at a position farthest from an upstream end of the guiding plate in a left-right direction.

21. The attachment according to claim 20, wherein
in the pot seedling guide portion, a straight line extending parallel to a same direction as a traveling direction is defined as a reference line, and
the resistance imparting portion is arranged on the reference line.

22. The attachment according to claim 20, wherein
in the pot seedling guide portion, a straight line extending forward from between a pair of guide plates is defined as a reference line, and
the resistance imparting portion is arranged on the reference line.

23. The attachment according to claim 20, wherein
in the pot seedling guide portion, a straight line extending parallel to a same direction as a traveling direction is defined as a reference line,
the guiding plate is arranged alternately on left and right sides relative to the reference line so as to avoid overlapping with the reference line, and
the resistance imparting portion is arranged at a distance of less than ½ times a diameter of a pot of continuous pot seedlings from the reference line.

24. The attachment according to claim 20, wherein
in the pot seedling guide portion, a straight line extending forward from between a pair of guide plates is defined as a reference line,
the guiding plate is arranged alternately on left and right sides relative to the reference line so as to avoid overlapping with the reference line, and
the resistance imparting portion is arranged at a distance of less than ½ times a diameter of a pot of continuous pot seedlings from the reference line.

25. The attachment according to claim 20, wherein
in the pot seedling guide portion, a straight line extending parallel to a same direction as a traveling direction is defined as a reference line,
the guiding plate is arranged on the reference line, and
the resistance imparting portion is arranged at a distance within twice a diameter of a pot of continuous pot seedlings from the reference line.

26. The attachment according to claim 20, wherein
in the pot seedling guide portion, a straight line extending forward from between a pair of guide plates is defined as a reference line,
the guiding plate is arranged on the reference line, and
the resistance imparting portion is arranged at a distance within twice a diameter of a pot of continuous pot seedlings from the reference line.

27. The attachment according to claim 20, wherein
in the pot seedling guide portion, a straight line extending parallel to a same direction as a traveling direction is defined as a reference line,
on the bottom plate, the guiding plate arranged at a position spaced from the reference line such that the resistance imparting portion is arranged at a distance of less than ½ times a diameter of a pot of continuous pot seedlings from the reference line, and the guiding plate arranged on the reference line such that the resistance imparting portion is arranged at a distance within twice the diameter of the pot of continuous pot seedlings from the reference line are disposed.

28. The attachment according to claim 20, wherein
in the pot seedling guide portion, a straight line extending forward from between a pair of guide plates is defined as a reference line,
on the bottom plate, the guiding plate arranged at a position spaced from the reference line such that the resistance imparting portion is arranged at a distance of less than ½ times a diameter of a pot of continuous pot seedlings from the reference line, and the guiding plate arranged on the reference line such that the resistance imparting portion is arranged at a distance within twice the diameter of the pot of continuous pot seedlings from the reference line are disposed.

29. The attachment according to claim 20, wherein
the guiding plate includes a curved guiding surface that is convex toward a movement path side of continuous pot seedlings.

30. A continuous pot seedling transplanter comprising:
a pot seedling placing portion disposed at a front portion of a transplanter body, on which an assemblage of continuous pot seedlings is placed;
a pot seedling guide portion that aligns a row of continuous pot seedlings pulled out from an assemblage of continuous pot seedlings as the transplanter body moves; and
a pot seedling delivery portion that is disposed at a rear portion of the transplanter body and delivers continuous pot seedlings aligned by the pot seedling guide portion to a planting furrow, wherein
the attachment according to claim 19 is disposed on the pot seedling guide portion.

31. A continuous pot seedling transplanter comprising:
a pot seedling placing portion disposed at a front portion of a transplanter body, on which an assemblage of continuous pot seedlings is placed;
a pot seedling guide portion that aligns a row of continuous pot seedlings pulled out from an assemblage of continuous pot seedlings as the transplanter body moves; and
a pot seedling delivery portion that is disposed at a rear portion of the transplanter body and delivers continuous pot seedlings aligned by the pot seedling guide portion to a planting furrow, wherein
the continuous pot seedling transplanter includes two or more guiding plates that are disposed on a bottom plate of the pot seedling guide portion and cause continuous pot seedlings pulled out from an assemblage of continuous pot seedlings to stand upright, and
the guiding plates are arranged alternately on left and right sides along a movement path of continuous pot seedlings.

32. The continuous pot seedling transplanter according to claim 31, wherein
the guiding plate includes a resistance imparting portion that comes in contact with continuous pot seedlings to impart a resistance against a moving direction, and
the resistance imparting portion is disposed at a position farthest from an upstream end of the guiding plate in a left-right direction.

33. The continuous pot seedling transplanter according to claim 32, wherein
in the pot seedling guide portion, a straight line extending parallel to a same direction as a traveling direction is defined as a reference line, and
the resistance imparting portion is arranged on the reference line.

34. The continuous pot seedling transplanter according to claim 32, wherein
in the pot seedling guide portion, a straight line extending forward from between a pair of guide plates is defined as a reference line, and
the resistance imparting portion is arranged on the reference line.

35. The continuous pot seedling transplanter according to claim 32, wherein
in the pot seedling guide portion, a straight line extending parallel to a same direction as a traveling direction is defined as a reference line,
the guiding plate is arranged alternately on left and right sides relative to the reference line so as to avoid overlapping with the reference line, and
the resistance imparting portion is arranged at a distance of less than ½ times a diameter of a pot of continuous pot seedlings from the reference line.

36. The continuous pot seedling transplanter according to claim 32, wherein
in the pot seedling guide portion, a straight line extending forward from between a pair of guide plates is defined as a reference line,
the guiding plate is arranged alternately on left and right sides relative to the reference line so as to avoid overlapping with the reference line, and
the resistance imparting portion is arranged at a distance of less than ½ times a diameter of a pot of continuous pot seedlings from the reference line.

37. The continuous pot seedling transplanter according to claim 32, wherein
in the pot seedling guide portion, a straight line extending parallel to a same direction as a traveling direction is defined as a reference line,
the guiding plate is arranged on the reference line, and
the resistance imparting portion is arranged at a distance within twice a diameter of a pot of continuous pot seedlings from the reference line.

38. The continuous pot seedling transplanter according to claim 32, wherein
in the pot seedling guide portion, a straight line extending forward from between a pair of guide plates is defined as a reference line,
the guiding plate is arranged on the reference line, and
the resistance imparting portion is arranged at a distance within twice a diameter of a pot of continuous pot seedlings from the reference line.

39. The continuous pot seedling transplanter according to claim 32, wherein
in the pot seedling guide portion, a straight line extending parallel to a same direction as a traveling direction is defined as a reference line,
on the bottom plate, the guiding plate arranged at a position spaced from the reference line such that the resistance imparting portion is arranged at a distance of less than ½ times a diameter of a pot of continuous pot seedlings from the reference line, and the guiding plate arranged on the reference line such that the resistance imparting portion is arranged at a distance within twice the diameter of the pot of continuous pot seedlings from the reference line are disposed.

40. The continuous pot seedling transplanter according to claim 32, wherein
in the pot seedling guide portion, a straight line extending forward from between a pair of guide plates is defined as a reference line,
on the bottom plate, the guiding plate arranged at a position spaced from the reference line such that the resistance imparting portion is arranged at a distance of less than ½ times a diameter of a pot of continuous pot seedlings from the reference line, and the guiding plate arranged on the reference line such that the resistance imparting portion is arranged at a distance within twice the diameter of the pot of continuous pot seedlings from the reference line are disposed.

40. The continuous pot seedling transplanter according to claim 31, wherein
the guiding plate includes a curved guiding surface that is convex toward a movement path of continuous pot seedlings.

41. A method for producing a crop comprising
transplanting continuous pot seedlings into a field using the continuous pot seedling transplanter according to claim 31.
